(19) United States
(12) Patent Application Publication
(10) Pub. No.: US 2023/0294898 A1
(43) Pub. Date: Sep. 21, 2023

(54) FROZEN GYOZA DUMPLINGS WITH SUPPORT

(71) Applicant: AJINOMOTO CO., INC., Tokyo (JP)

(72) Inventors: Yuko SHIMIZU, Kawasaki-shi (JP); Daiki SAITO, Kawasaki-shi (JP); Yui SAITO, Kawasaki-shi (JP); Yoshinori KODANI, Kawasaki-shi (JP); Kaoru HOSOKAWA, Kawasaki-shi (JP)

(73) Assignee: AJINOMOTO CO., INC., Tokyo (JP)

(21) Appl. No.: 18/185,490

(22) Filed: Mar. 17, 2023

(30) Foreign Application Priority Data
Mar. 18, 2022 (JP) 2022-044585

(51) Int. Cl. B65D 77/04; A23P 20/10; A23L 3/36; B65D 85/00

(52) U.S. Cl. CPC B65D 77/0433; A23P 20/10; A23L 3/36; B65D 85/70

(57) ABSTRACT

The frozen gyoza dumplings with a support, containing a plurality of frozen gyoza dumplings connected by a wing-forming frozen composition, and a support in contact with a connecting surface thereof, wherein the support has a shape permitting the frozen gyoza dumplings in a connected state to slide thereon, or is deformed so as to permit sliding, make it possible to arrange gyoza dumplings all at once on a cooking utensil such as a frying pan by sliding them on the support without touching the gyoza dumplings with a hand.

### CROSS REFERENCES TO RELATED APPLICATION

This application claims priority to Japanese Patent Application No. 2022-044585, filed on Mar. 18, 2022, which is incorporated herein by reference in its entirety.

### BACKGROUND OF THE INVENTION

### Field of the Invention

The present invention relates to frozen gyoza dumplings with a support, containing a plurality of frozen gyoza dumplings connected by a wing-forming frozen composition, and a support in contact with a connecting surface thereof.

### Discussion of the Background

In conventional frozen gyoza dumpling products, plural frozen gyoza dumplings are stored one by one in a tray with steps. When cooking the frozen gyoza dumplings, it is necessary to take out the gyoza dumplings one by one from the tray and arrange them on a cooking utensil such as a frying pan. It is troublesome and also causes a problem of poor finish because the wing-forming frozen composition partly melts before arranging the whole gyoza dumplings. In addition, there are some complaints about dirty hands when removing the gyoza dumplings from the tray by hand. Therefore, there is a need to save time and effort in arranging a plurality of frozen gyoza dumplings by taking them out all at once, as well as to provide frozen gyoza dumplings that do not cause dirty hands.

Various proposals have conventionally been made for frozen gyoza dumplings consisting of a plurality of connected frozen gyoza dumplings. For example, frozen connected gyoza dumplings with a wing forming emulsion composition (see JP-B-4483268, which is incorporated herein by reference in its entirety), frozen gyoza dumplings in a tray in which plural gyoza dumplings are connected to each other and immobilized on the tray bottom surface (see JP-B-4584497, which is incorporated herein by reference in its entirety), tray for gyoza dumplings capable of connecting and freezing plural gyoza dumplings (see JP-A-H11-56313, which is incorporated herein by reference in its entirety), fats and oils composition for gyoza dumplings which is used for connecting and solidifying by freezing gyoza dumplings (see JP-B-6646963, which is incorporated herein by reference in its entirety), and the like are known.

### SUMMARY OF THE INVENTION

However, since these frozen gyoza dumplings stored in a tray are enclosed in an outer package bag, taking them out while still connected requires a complicated operation of, for example, removing the frozen gyoza dumplings from the tray by lifting them with both hands and then placing them on a cooking utensil. In addition, the frustration of dirty hands still remains.

As JP-B-4584497 and JP-A-H11-56313 recite “synthetic resins such as polypropylene and the like” as examples, conventional trays for frozen gyoza dumplings are made of plastic. This makes the trays bulky when disposing of waste after cooking, and the environmental damage caused by plastic waste is a problem.

In view of the above-mentioned problems, the present invention aims to provide frozen gyoza dumplings that save the trouble of removing frozen gyoza dumplings one by one by hand from the tray. The present invention also aims to decrease plastic waste by not using plastic trays. The present invention further aims to provide frozen gyoza dumplings that are equivalent to or higher than conventional products in the quality such as taste and the like, while solving the above-mentioned problems.

These and other objects, which will become apparent during the following detailed description, have been achieved by the present inventor's discovery that the above-mentioned problems can be solved by combining a plurality of frozen gyoza dumplings connected by a wing-forming frozen composition with a support capable of sliding thereon the gyoza dumplings in a connected state. The present inventors have further successfully produced an eco-friendly frozen gyoza dumpling product in which soaking of a melted wing-forming frozen composition into a support and deterioration of the product are prevented by using, as the support, paper processed to be water-resistant at least on the surface in contact with the connecting surface of the plurality of connected frozen gyoza dumplings. The present inventors have also successfully produced frozen gyoza dumplings that do not crack even when dropped, maintain a connected state even after refreezing after thawing, are capable of sliding on the support, and do not adversely affect the quality of finish such as an unburnt residue of the wing-forming composition, by optimizing the thickness of the wing-forming frozen composition and the distance between the closest frozen gyoza dumplings, which resulted in the completion of the present invention.

The main constitutions of the present invention are as follows.
(1) Frozen gyoza dumplings with a support, comprising a plurality of frozen gyoza dumplings connected by a wing-forming frozen composition, and a support in contact with a connecting surface thereof, wherein the support has a shape permitting the frozen gyoza dumplings in a connected state to slide thereon, or is deformed so as to permit sliding.
(2) The frozen gyoza dumplings of (1), wherein the support is a package container, and the plurality of connected frozen gyoza dumplings is directly enclosed in the package container.
(3) The frozen gyoza dumplings of (2), wherein the package container is an outer packaging bag.
(4) The frozen gyoza dumplings of (2), wherein the package container is a box body.
(5) The frozen gyoza dumplings of (1), Wherein the support is a flat plate body or a deformed body thereof, or a box body.
(6) The frozen gyoza dumplings of (5), wherein the plurality of connected frozen gyoza dumplings and the support are enclosed in a bag.
(7) The frozen gyoza dumplings of (4) or (5), wherein at least a surface of the package container or the support, which surface is in contact with the plurality of connected frozen gyoza dumplings, is water resistant.
(8) The frozen gyoza dumplings of (7), wherein the package container or the support is water-resistant paper.
(9) The frozen gyoza dumplings of any one of (1) to (8), wherein the connecting surface of the plurality of connected frozen gyoza dumplings is polygonal or substantially circular.
(10) The frozen gyoza dumplings of (4) or any one of (5) to (8) in which the support is a box body, wherein all or a part of the side surfaces of the box body does not exist or is deformed so as to not exist, or is inclined at 30 degrees or more from the vertical direction or deformed so as to be inclined, so that the plurality of connected frozen gyoza dumplings is taken out in a connected state from the box body by sliding the frozen gyoza dumplings on the box body.
(11) The frozen gyoza dumplings of (10), wherein the all or part of the side surfaces of the box body is inclined 30 to 90 degrees from the vertical direction.
(12) The frozen gyoza dumplings of (10), wherein the all or part of the side surfaces of the box body is deformed to be aligned with the bottom surface of the box body.
(13) The frozen gyoza dumplings of (10), wherein the box body comprises a tear-off zipper, and all or a part of the side surfaces of the box body is broken by pulling off the tear-off zipper.
(14) The frozen gyoza dumplings of any one of (1) to (13), wherein the wing-forming frozen composition has a thickness of 3 to 10 mm.
(15) The frozen gyoza dumplings of any one of (1) to (14), wherein a distance between the closest frozen gyoza dumplings is 3 to 10 mm.

### Effect of the Invention

According to the frozen gyoza dumplings with a support of the present invention, it is possible to arrange gyoza dumplings all at once on a cooking utensil such as a frying pan by sliding them on the support without touching the gyoza dumplings with a hand.

In addition, according to the frozen gyoza dumplings with a support of the present invention, it is possible to omit the use of a tray, and garbage generated after cooking which is to be thrown away is not bulky.

Furthermore, according to the frozen gyoza dumplings with a support of the present invention, it is possible to omit the use of plastic trays, which is environmentally friendly.

### BRIEF DESCRIPTION OF THE DRAWINGS

FIG. 1 shows examples of the shape of Plural Connected Frozen Gyoza 100 connected by a wing-forming frozen composition 102, and the arrangement of the frozen gyoza dumplings 101.

FIG. 1(a-1) is a plan view of Plural Connected Frozen Gyoza 100 having a substantially rectangular connecting surface, FIG. 1(b) is a plan view of Plural Connected Frozen Gyoza 100 having a substantially square connecting surface, and FIG. 1(c) is a plan view of Plural Connected Frozen Gyoza 100 having a substantially circular connecting surface. In addition, FIG. 1(a-2) is a front view of Plural Connected Frozen Gyoza 100 of FIG. 1(a-1).

FIG. 2-1 is a schematic view of Embodiment 1 (when connecting surface is substantially rectangular; Embodiment 1-1) of the frozen gyoza dumplings with a support of the present invention. FIG. 2-1(a) is a plan view of Embodiment 1-1. FIG. 2-1(b) is a schematic view indicating that Plural Connected Frozen Gyoza 100 is being taken out of a bag 200. In the Figure, a line that is not actually visible is drawn with a broken line.

FIG. 2-2 is a schematic view of Embodiment 1 (when connecting surface is substantially circular; Embodiment 1-2) of the frozen gyoza dumplings with a support of the present invention. FIG. 2-2(a) is a plan view of Embodiment 1-2. FIG. 2-2(b) is a schematic view indicating that Plural Connected Frozen Gyoza 100 is being taken out of a bag 200. In the Figure, a line that is not actually visible is drawn with a broken line.

FIG. 3-1 is a schematic view of Embodiment 2 (when connecting surface is substantially rectangular; Embodiment 2-1) of the frozen gyoza dumplings with a support of the present invention. FIG. 3-1(a) is a plan view of Embodiment 2-1. FIG. 3-1(b) and (c) are schematic views indicating that Plural Connected Frozen Gyoza 100 is being taken out of packages. In the Figure, a line that is not actually visible is drawn with a broken line.

FIG. 3-2 is a schematic view of Embodiment 2 (when connecting surface is substantially circular; Embodiment 2-2) of the frozen gyoza dumplings with a support of the present invention. FIG. 3-2(a) is a plan view of Embodiment 2-2. FIG. 3-2(b) and (c) are schematic views indicating that Plural Connected Frozen Gyoza 100 is being taken out of packages. In the Figure, a line that is not actually visible is drawn with a broken line.

FIG. 3-3 is a schematic view of one embodiment in which the support is a deformed flat plate body. FIG. 3-3(a) is an oblique projection drawing in which Plural Connected Frozen Gyoza 100 is placed on a support 300 which is a deformed flat plate body. FIG. 3-3(b) is a schematic view indicating that Plural Connected Frozen Gyoza 100 is being slid from the deformed support 300 of the flat plate body. In the Figure, a line that is not actually visible is drawn with a broken line.

FIG. 4-1 is a schematic view of Embodiment 3 (when connecting surface is substantially rectangular; Embodiment 3-1) of the frozen gyoza dumplings with a support of the present invention. FIG. 4-1(a) is an oblique projection drawing of Embodiment 3-1. FIG. 4-1(b) is a schematic view indicating that Plural Connected Frozen Gyoza 100 is being taken out of a box body. In the Figure, a line that is not actually visible is drawn with a broken line.

FIG. 4-2 is a schematic view of Embodiment 3 (when connecting surface is substantially circular; Embodiment 3-2) of the frozen gyoza dumplings with a support of the present invention. FIG. 4-2(a) is an oblique projection drawing of Embodiment 3-2. FIG. 4-2(b) is a schematic view indicating that Plural Connected Frozen Gyoza 100 is being taken out of a box body. In the Figure, a line that is not actually visible is drawn with a broken line.

FIG. 5-1 is a schematic view of Embodiment 4 (when connecting surface is substantially rectangular; Embodiment 4-1) of the frozen gyoza dumplings with a support of the present invention. FIG. 5-1(a) is an oblique projection drawing of Embodiment 4-1. FIG. 5-1(b) is a schematic view indicating that Plural Connected Frozen Gyoza 100 is being taken out of a box body. In the Figure, a line that is not actually visible is drawn with a broken line.

FIG. 5-2 is a schematic view of Embodiment 4 (when connecting surface is substantially circular; Embodiment 4-2) of the frozen gyoza dumplings with a support of the present invention. FIG. 5-2(a) is an oblique projection drawing of Embodiment 4-2. FIG. 5-2(b) is a schematic view indicating that Plural Connected Frozen Gyoza 100 is being taken out of a box body.

FIG. 6-1 is a schematic view of Embodiment 5 (when connecting surface is substantially rectangular; Embodiment 5-1) of the frozen gyoza dumplings with a support of the present invention. FIG. 6-1(a) is an oblique projection drawing of Embodiment 5-1. FIG. 6-1(b) and (c) are schematic views indicating that Plural Connected Frozen Gyoza 100 is being taken out of a box body. In the Figure, a line that is not actually visible is drawn with a broken line. On the right side of the curve crossing the box body in FIG. 6-1(a), illustration of the frozen gyoza dumplings is omitted.

FIG. 6-2 is a schematic view of Embodiment 5 (when connecting surface is substantially circular; Embodiment 5-2) of the frozen gyoza dumplings with a support of the present invention. FIG. 6-2(a) is an oblique projection drawing of Embodiment 5-2. FIG. 6-2(b) and (c) are schematic views indicating that Plural Connected Frozen Gyoza 100 is being taken out of a box body. In the Figure, a line that is not actually visible is drawn with a broken line.

### DETAILED DESCRIPTION OF THE PREFERRED EMBODIMENTS

The frozen gyoza dumplings with a support of the present invention consist of a formed product in which a plurality of frozen gyoza dumplings 101 are connected by a wing-forming frozen composition 102 (also to be referred to as “Plural Connected Frozen Gyoza”, “Connected Frozen Gyoza”) 100, and a support in contact with a connecting surface thereof. The support has a shape permitting the frozen gyoza dumplings 101 in a connected state (i.e., formed product 100) to slide thereon, or deformable so as to permit sliding.

The shape and size of the gyoza dumplings used for frozen gyoza dumplings 101 in the frozen gyoza dumplings with a support of the present invention, the material, thickness, size and shape (generally a circular shape) of dough, and components, constitution, amount, and cooking method of filling, which are used for production, are not particularly limited, and the manufacture method of filling and dough, wrapping manner and the like can be those known to one of ordinary skill in the art. As one embodiment, “GYOZA” manufactured by Ajinomoto Co., Inc. can be mentioned.

The composition of the wing-forming composition constituting the wing-forming frozen composition 102 in the frozen gyoza dumplings with a support of the present invention (hereinafter to be also simply referred to as “wing-forming composition”) is not particularly limited, and those of ordinary skill in the art can appropriately determine the composition. Examples include those containing water, starch, modified starch, oils and fats, emulsifiers and thickeners. They may also contain grain flour, proteins, emulsifying aids, seasonings, salts, sugars, amino acids, celluloses, and the like.

The connecting surface of Plural Connected Frozen Gyoza 100 may be a polygon, or a substantially circular shape. When the connecting surface is a polygon, examples of the polygon include triangle, quadrangle, pentagon, hexagon, octagon, dodecagon, and the like. Quadrangle is preferred, and substantial rectangle and substantial square are more preferred.

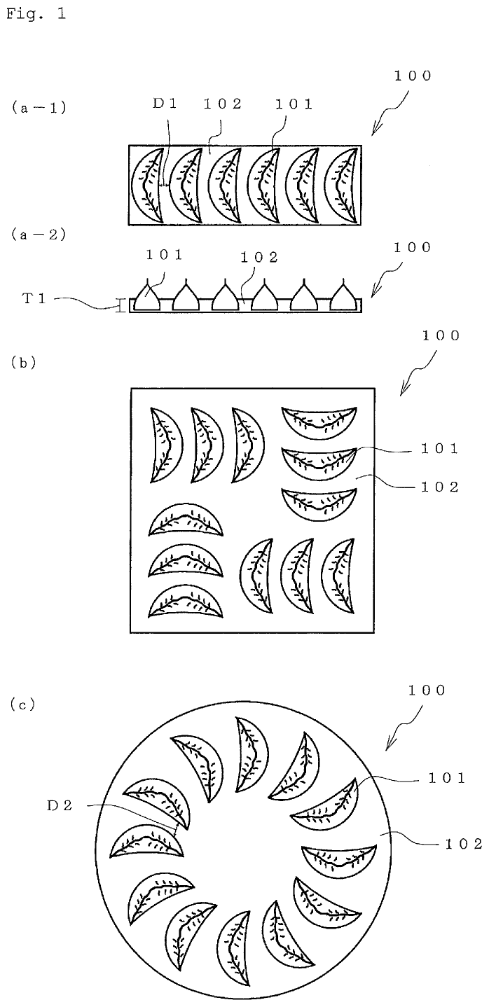

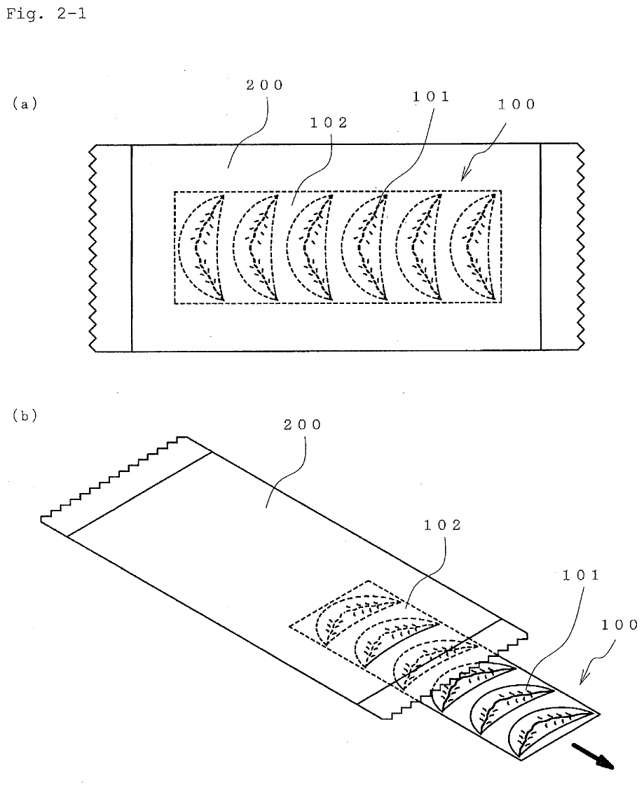

When the polygon is substantially rectangular, examples thereof include one in which a plurality of frozen gyoza dumplings 101 are arranged in tandem as shown in FIG. 1(a-1). In the present specification, this arrangement is referred to as “tandem type”. In the example shown in FIG. 1(a-1), 6 frozen gyoza dumplings 101 are connected. For example, connecting surfaces of subdivided gyoza dumplings may be combined to form a substantially rectangular shape (e.g., when the total number of frozen gyoza dumplings 101 is 6, two sets of three connected frozen gyoza dumplings 101, three sets of two connected frozen gyoza dumplings 101, etc.). In the example shown in FIG. 1(a-1), one raw of Connected Frozen Gyoza 100 is shown. For example, connecting surfaces of plural rows of Connected Frozen Gyoza 100 may form a substantially rectangular shape. In this case, all the plural rows of frozen gyoza dumplings 101 may be connected to form a substantially rectangular shape. Alternatively, several rows of Connected Frozen Gyoza 100 may be combined to form a discontinuous connecting surface of a substantially rectangular shape as a whole. The matters described above with an example of a substantially rectangular shape may be applied to the following substantially square shape as long as they are applicable.

When the polygon is substantially square, examples thereof include one in which some sets (four sets in the example of FIG. 1(b)) of a plurality (three in the example of FIG. 1(b)) of frozen gyoza dumplings 101 are arranged in different directions from the adjacent sets (facing each other perpendicularly in the example of FIG. 1(b), the whole connecting surface forming a substantially square shape. In this case, all the frozen gyoza dumplings 101 may be connected to form a substantially square connecting surface. Alternatively, several sets of Connected Frozen Gyoza 100 may be combined to form a discontinuous connecting surface of a substantially square shape as a whole. The matters described above with an example of a substantially square shape may be applied to the above-mentioned substantially rectangular shape as long as they are applicable.

The matters described above with examples of a substantially rectangular shape and a substantially square shape may be applied to other polygons and the following substantially circular shape as long as they are applicable.

FIG. 1 (c) shows an example in which the connecting surface of Plural Connected Frozen Gyoza 100 is a substantially circular shape. In the present specification, this arrangement is referred to as “disc type”.

A method for producing Plural Connected Frozen Gyoza 100 connected by the wing-forming frozen composition 102 is not particularly limited. One example includes a method including the following steps.

(step S1) a step of bringing a plurality of unfrozen gyoza dumplings (raw gyoza dumplings with fillings wrapped in dough) or frozen gyoza dumplings with the lower surface facing downward in contact with the wing-forming composition

(step S2) a step of freezing a plurality of unfrozen gyoza dumplings or frozen gyoza dumplings and the wing-forming composition in the state obtained in step S1, thereby obtaining a plurality of frozen gyoza dumplings connected by the wing-forming frozen composition. Before freezing, the gyoza dumplings may be subjected to an appropriate preliminary heat treatment such as steaming or boiling, or a treatment meeting the need.

In the above-mentioned step S1, the method for integrating the wing-forming composition in a frozen state with the lower surface of the unfrozen gyoza dumplings or frozen gyoza dumplings may be any and, for example, a method using a mold for positioning the wing-forming composition with respect to the gyoza dumplings, or a method for applying a wing-forming composition with increased viscosity by cooling to gyoza dumplings may be used.

By sequentially performing the above-mentioned steps S1 and S2 in the container, Plural Connected Frozen Gyoza 100 connected by the wing-forming frozen composition 102 can be completed while being stored in the container. The obtained Connected Frozen Gyoza 100 may be placed on an appropriate support, or can be directly used as the frozen gyoza dumplings with a support of the present invention when the container used for freezing satisfies the requirements of an appropriate support.

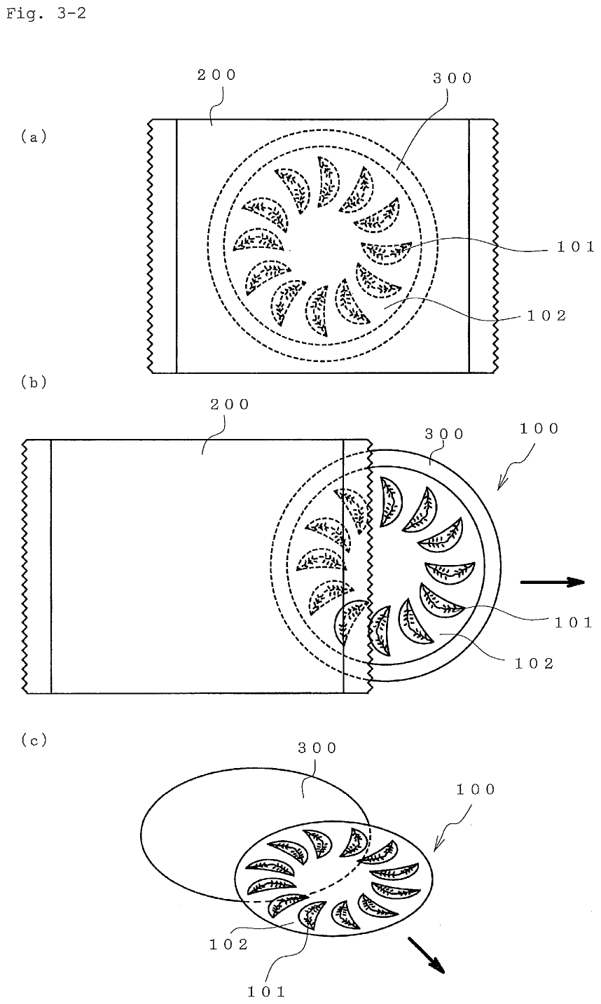

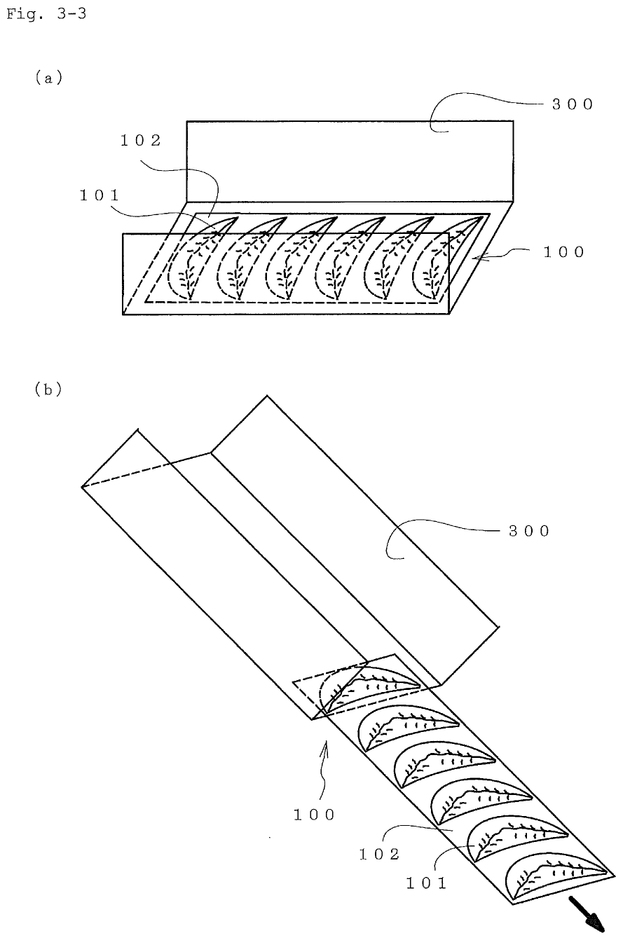

The support in the frozen gyoza dumplings with a support of the present invention is not particularly limited as long as the Connected Frozen Gyoza 100 slides on the support as it is (i.e., remains connected) and is placed on a cooking utensil such as a frying pan at once. The support may be a package container capable of storing, transporting, and distributing the frozen gyoza dumplings with a support, or a flat plate body, a deformed body of the flat plate body, a box body, or the like enclosed in an outer packaging bag, etc. As used herein, the deformed body of a flat plate body refers to a flat plate body having a rising portion formed by raising a part of the end of the flat plate body or a flat plate body with a separately prepared rising portion connected to a part of the end of the flat plate body. One embodiment thereof is described later with reference to FIG. 3-3. The rising portion may function as a guide when the Connected Frozen Gyoza 100 is slid, and may function as a stopper to prevent position out of the Connected Frozen Gyoza 100.

The material of the support is not particularly limited and, for example, paper, flexible film, a laminate of both, plastic, pulp mold, silicone resin, rubber, aluminum foil, a laminate of these materials, and the like are used as appropriate. In consideration of the effects such as not bulky when throwing away garbage and being environmentally friendly, paper, flexible film, a laminate of both, and the like are preferably used.

When the support is a package container, Plural Connected Frozen Gyoza 100 is directly enclosed in the package container.

The package container may be an outer packaging bag, or a box body without an outer packaging bag as long as it can be stored, transported, and distributed by itself. In this case, the box body is of a closed type having at least a top surface.

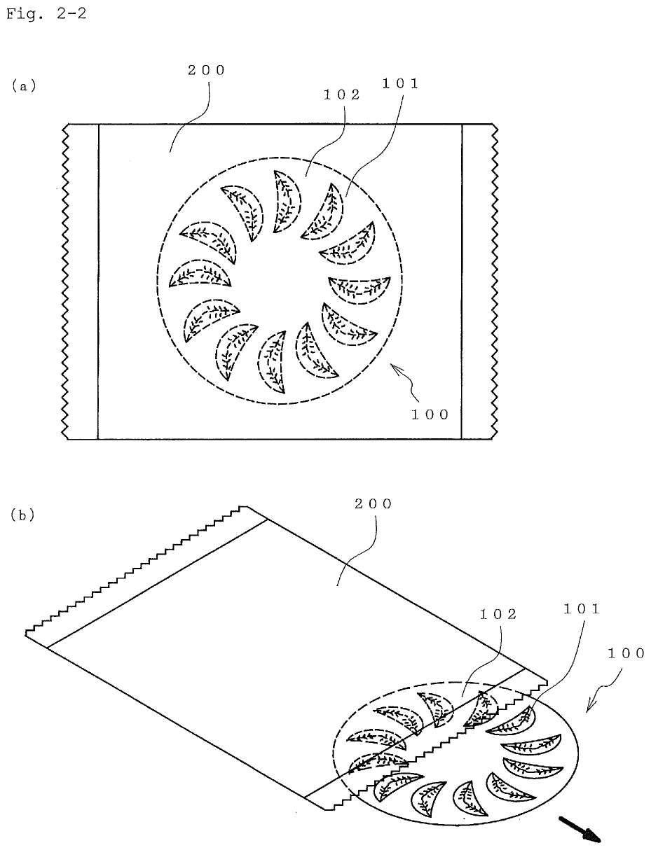

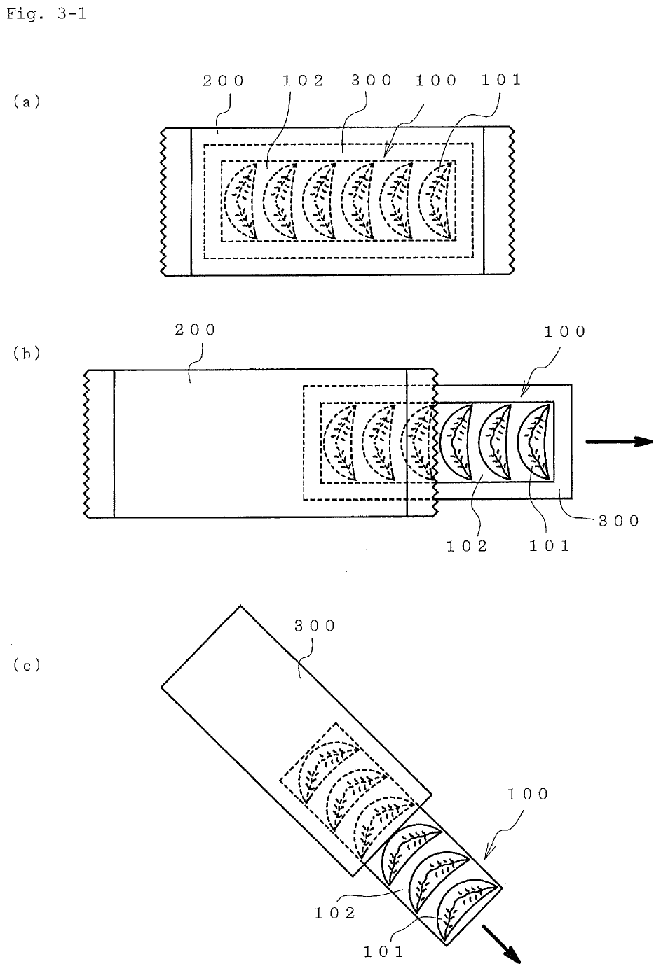

When the package container is an outer packaging bag, the bag is not particularly limited as long as it can enclose Connected Frozen Gyoza 100 as it is, and the Connected Frozen Gyoza 100 enclosed inside can slide on the inner surface of the bag as it is when the bag is opened and tilted. In one embodiment, the bag may be a flat packaging bag 200 made of a flexible film (e.g., a single layer film of polypropylene, polyethylene terephthalate, polyamide, cellophane, polyolefin, polyethylene, or a multilayer laminate of these), paper, or the like. In the present specification, this embodiment is referred to as “Embodiment 1”, and the outline thereof is shown in FIG. 2-1 and FIG. 2-2. FIG. 2-1(a) and FIG. 2-2(a) are plan views of packages enclosing Connected Frozen Gyoza 100 in packaging bags 200. FIG. 2-1(b) and FIG. 2-2(b) depict when the packages of FIG. 2-1(a) and FIG. 2-2(a) are tilted, and the Connected Frozen Gyoza 100 is slid in the arrow direction as it is.

When actually taking out the Connected Frozen Gyoza 100 from the bag 200, whether the bag is tilted to allow the dumplings to slide out or, for example, wing-forming frozen composition 102 near the opening is picked by hand and pulled out may be appropriately selected by the consumer. In consideration of hygiene, it is desirable that the Connected Frozen Gyoza 100 slides out when the bag is simply held and tilted.

When the package container is a box body, the box body is not particularly limited as long as it has a closed space in which the Connected Frozen Gyoza 100 can be placed as it is. When the package container is a box body, the outer shape of the box body is not particularly limited as long as it is a columnar body having a bottom shape capable of storing the Connected Frozen Gyoza 100. According to the shape of the connecting surface of the Connected Frozen Gyoza 100, a substantially rectangular shape, a substantially cubic shape, a substantially inverted conical trapozoidal shape, and a substantially cylindrical shape can be mentioned.

When the support is a flat plate body, or a deformed body thereof, or a box body in which the whole or a part of a top surface is open and/or the whole or a part of the side surface from which the Connected Frozen Gyoza 100 is discharged is open, the support is enclosed in a package container, for example, an outer packaging bag or the like, together with the Connected Frozen Gyoza 100. For example, in FIG. 3-1(a) and FIG. 3-2(a), Connected Frozen Gyoza 100 is placed on a support 300, which is a flat plate body, and enclosed in a packaging bag 200. FIG. 3-1(b) and FIG. 3-1(c), as well as FIG. 3-2(b) and FIG. 3-2(c) respectively show embodiments of taking out the Connected Frozen Gyoza 100 from the packages of FIG. 3-1(a) and FIG. 3-2(a). In these embodiments, the packaging bag 200 is tilted to allow the dumplings to slide out, or the support 300 near the opening is picked by hand and the whole support together with the Connected Frozen Gyoza 100 is pulled out in the arrow direction from the packaging bag 200, and the Connected Frozen Gyoza 100 is slid in the arrow direction by tilting the support 300. In another embodiment, the support 300 near the opening is picked by hand and a part of the support is pulled out together with the Connected Frozen Gyoza 100 from the packaging bag 200, and the Connected Frozen Gyoza 100 is slid by tilting the support 300. In a still another embodiment, the packaging bag 200 and the support 300 are held and tilted to allow the Connected Frozen Gyoza 100 to slide as it is. FIG. 3-3 shows one embodiment in which the support is a deformed flat plate body. In FIG. 3-3(a), the Connected Frozen Gyoza 100 is placed on the support 300 which is a deformed flat plate body obtained by forming a rising portion by raising the both ends of a rectangular flat plate body in the vertical direction along the direction of sliding of the Connected Frozen Gyoza 100. In FIG. 3(b), the Connected Frozen Gyoza 100 is slid in the arrow direction by tilting the support 300.

When the support is a box body enclosed in an outer packaging bag or the like, the box body is not particularly limited as long as it has a space in which the Connected Frozen Gyoza 100 can be placed as it is. The space is not necessarily closed (e.g., top surface of the box body or a part of the side surfaces may be open). When the support is a box body, the outer shape of the box body is not particularly limited as long as it is a columnar body having a bottom shape capable of storing the Connected Frozen Gyoza 100. According to the shape of the connecting surface of the Connected Frozen Gyoza 100, a substantially rectangular shape, a substantially cubic shape, a substantially inverted conical trapozoidal shape, and a substantially cylindrical shape can be mentioned.

When the package container is a box body, or when the support enclosed in the outer packaging bag is a box body, all or a part of the side surfaces of the box body preferably does not exist or can be deformed so as to not exist, or is preferably inclined at a given angle, for example, 30 degrees or more, with respect to the vertical direction or has a shape that can be deformed so as to be inclined, so that Plural Connected Frozen Gyoza 100 can be taken out in a connected state from the box body by sliding the frozen gyoza dumplings on a surface in contact with the connecting surface of the box body.

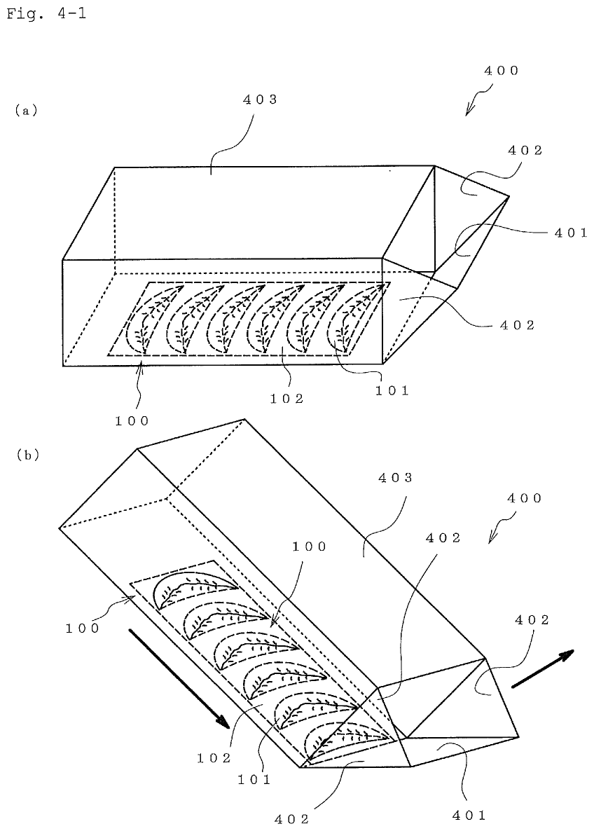

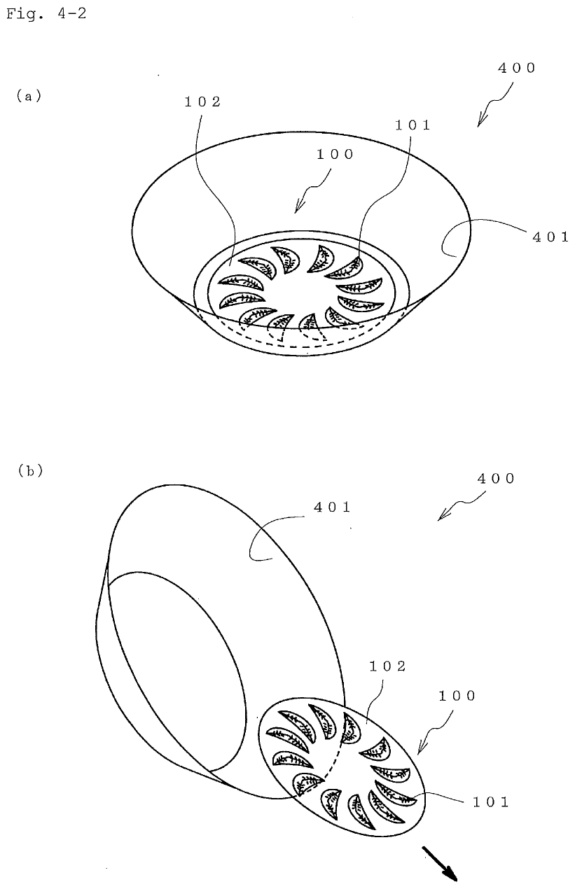

In one embodiment, all or a part of the side surfaces of a box body may be inclined by 30 to 90 degrees from the vertical direction, or may have a shape that can be deformed so as to be inclined. When a part of the side surfaces of the box body is inclined, the inclined part is not particularly limited as long as the Connected Frozen Gyoza 100 can be smoothly slid and taken out of the box body. A preferable inclination angle is, for example, 40 to 80 degrees. In the present specification, an embodiment in which the support is a box body 400, all or a part of the side surfaces of the box body is inclined 45 degrees from the vertical direction, or the box body has a shape that can be deformed so as to be inclined is referred to as “Embodiment 3”, and specific examples thereof are shown in FIG. 4-1 and FIG. 4-2. FIG. 4-1 shows an embodiment in which the box body is a substantially rectangular shape, and FIG. 4-2 shows an embodiment in which the box body is a substantially inverted conical trapozoidal shape. In FIG. 4-1(a), one side surface 401 of the box body 400 is inclined 45 degrees, and the inclination angle thereof is maintained by a stopper 402. The stopper 402 can be made of a flexible material, or can be freely opened and closed by valley folding, bellows, or the like. In this case, when the stopper 402 is closed, the box body 400 is a cuboid and when it particularly has a top surface 403, the box body 400 itself can serve as a package container. In FIG. 4-2(a), the entire side surface 401 of the substantially cylindrical box body is inclined outward by 45 degrees, and the inclination angle is maintained by the side surface acting as a stopper. Only a part of the side surface 401 (for example, continuous half or more) may be inclined as long as the Connected Frozen Gyoza 100 can be smoothly slid and taken out of the box body. The inclined portion of the side surface 401 can be made openable and closable by, for example, forming a bellows shape like an aluminum cup. In this case, when the side surface 401 is folded, the box body 400 is cylindrical. As shown in FIG. 4-1(b) and FIG. 4-2(b), when the box body 400 is tilted, the inclined side surface 401 becomes substantially horizontal with respect to cooking utensils such as a frying pan. Therefore, the Connected Frozen Gyoza 100 can be placed on a cooking utensil with less impact, and the Connected Frozen Gyoza 100 is expected to avoid breaking.

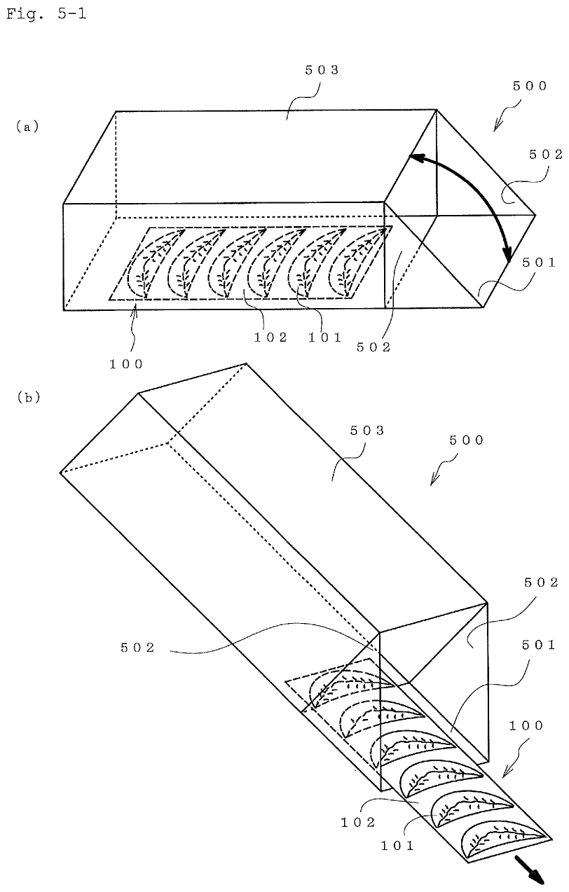

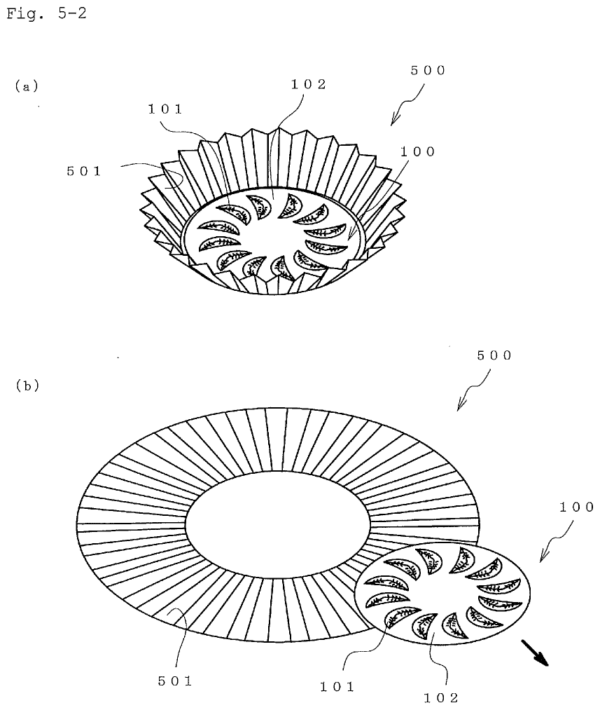

In addition, all or a part of the side surfaces of a box body may be deformed to be aligned with the bottom surface of the box body. This embodiment corresponds to the aforementioned Embodiment 3 in which the inclination angle is 90 degrees, and is a special embodiment in Embodiment 3. In the present specification, an embodiment using the aforementioned box body in which the support (package container) is a box body 500, and all or a part of the side surfaces of the box body is deformed by pulling to be aligned with the bottom surface of the box body is referred to as “Embodiment 4”, and specific examples thereof are shown in FIG. 5-1 and FIG. 5-2. FIG. 5-1 shows an embodiment in which one side surface 501 is closed, a box body 500 is a cuboid, and FIG. 5-2 shows an embodiment in which a box body 500 is an inverted conical trapozoidal shape with one side surface 501 closed. In FIG. 5-1(a), the side surface 501 is pulled to be aligned with the bottom surface of a box body 500, and such state is maintained by a stopper 502. The stopper 502 can be made of a flexible material; or can be freely opened and closed by valley folding, bellows, or the like. Particularly when the box body 500 has a top surface 503, the box body 500 itself can serve as a package container. In FIG. 5-2(a), the whole side surface 501 of a box body with an inverted conical trapozoidal shape is pulled to be aligned with the bottom surface of the box body 500. The aligned state is maintained by the side surface acting as a stopper. Only a part of the side surface 501 (for example, continuous half or more) may be aligned with the bottom surface of the box body 500 as long as the Connected Frozen Gyoza 100 can be smoothly slid and taken out of the box body. In FIG. 5-2(a), the pulling part of the side surface 501 has a bellows shape like an aluminum cup. For example, by inserting a large number of break lines (perforations) in the side surface 501 in the direction perpendicular to the bottom surface, the side surface can be freely opened and closed when pulled. As shown in FIG. 5-1(b) and FIG. 5-2(b), when the box body 500 is tilted, the Connected Frozen Gyoza 100 slides and is taken out of the box body 500. Alternatively, the wing-forming frozen composition 102 near the opening where the side surface 501 is aligned with the bottom surface of the box body 500 is pinched with a hand or the like, and the Connected Frozen Gyoza 100 as it is can be pulled out of the box body 500.

In Embodiment 4, by using a flexible material for the stopper 502, when the side surface 501 is placed on a cooking utensil such as a frying pan, the consumer can appropriately adjust the inclination angle so that the Connected Frozen Gyoza 100 is most easily slid and/or the Connected Frozen Gyoza 100 is less likely to break when discharged on the cooking utensil.

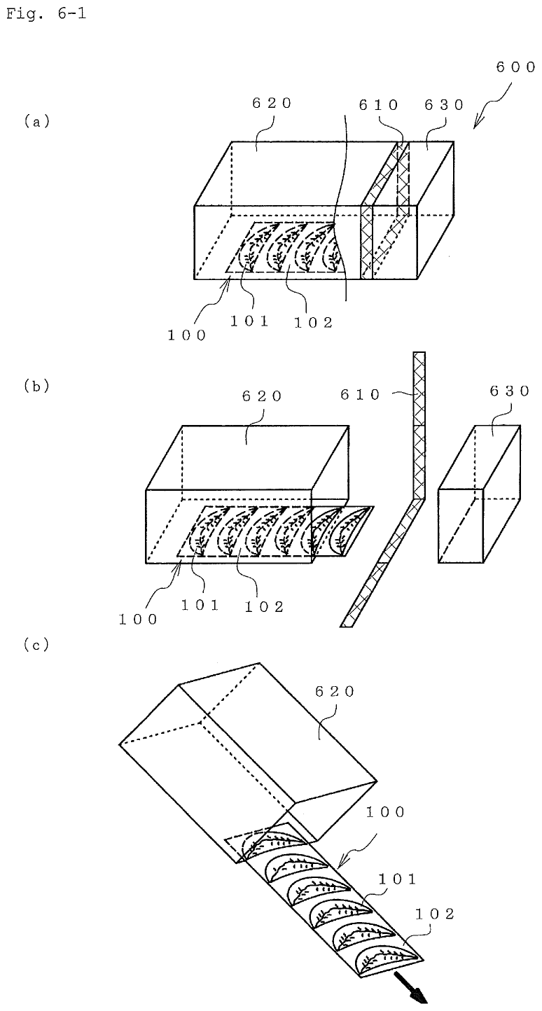

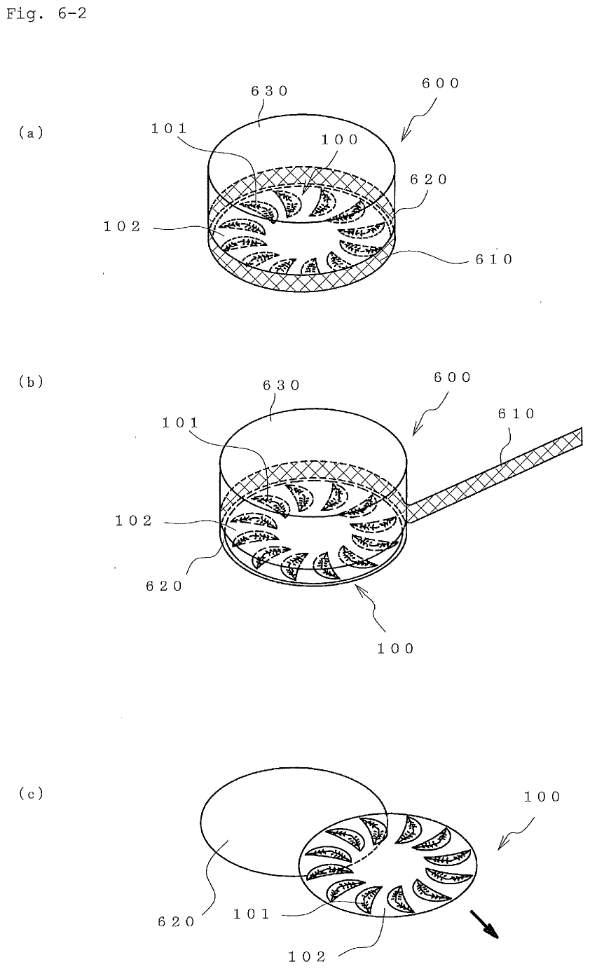

Furthermore, the box body may be designed to contain a tear-off zipper, where all or a part of the side surfaces of the box body is broken by pulling off the tear-off zipper. For example, the tear-off zipper may extend at least transversely or longitudinally across the top surface of the box body to the bottom of the two side surfaces of the box body (i.e., remains connected at the bottom surface), or may transversely or longitudinally cross also the bottom of the box (i.e. separates the box body into two parts). The tear-off zipper may also be provided in the left-right direction in a part or all of the side surface of the box body, at a predetermined height from the bottom surface (that is, the tear-off zipper has a predetermined width). Such predetermined height is not particularly limited as long as the Connected Frozen Gyoza 100 can be smoothly slid and taken out of the box body from the opening part formed by separating the tear-off zipper. For example, it is preferably higher than the height of the frozen gyoza dumpling. In the present specification, an embodiment using the aforementioned box body in which the support (package container) is a box body 600, and the box body is provided with a tear-off zipper 610 is referred to as “Embodiment 5”, and specific examples thereof are shown in FIG. 6-1 and FIG. 6-2. FIG. 6-1 shows an embodiment in which the box body 600 is a cuboid, and the tear-off zipper 610 is provided to separate the box body into two parts. FIG. 6-1(a) shows the state before pulling the tear-off zipper 610, and FIG. 6-1(b) shows the state after separating the box body 600 into two pieces (620, 630) by pulling the tear-off zipper 610, as a result of which a part of the Connected Frozen Gyoza 100 is exposed out of the box body. In FIG. 6-1(c), the piece 620 of the box body 600 containing the Connected Frozen Gyoza 100 is tilted to take out the Connected Frozen Gyoza 100 in the arrow direction. On the other hand, FIG. 6-2 shows an embodiment in which the box body 600 is cylindrical, and the tear-off zipper 610 is provided in the left-right direction on the entire side surface of the box body, at a predetermined height from the bottom surface. FIG. 6-2(a) shows the state before pulling the tear-off zipper 610, and FIG. 6-2(b) shows the state in which a part of the tear-off zipper 610 has been pulled to form, on the side surface of the box body 600, an opening through which the Connected Frozen Gyoza 100 can be slid and taken out of the box body. In FIG. 6-2(c), the piece of the box body 600 is tilted and the Connected Frozen Gyoza 100 is taken out in the arrow direction.

The frozen gyoza dumplings with a support of the present invention contains a plurality of frozen gyoza dumplings 101 connected by a wing-forming frozen composition 102, and the wing-forming frozen composition may melt while being exposed to the outside air during transportation and distribution. Thus, the package container and/or a support enclosed in the package container in the present invention is preferably water resistant at least on a surface in contact with Plural Connected Frozen Gyoza 100. In that respect, the package container or the support is preferably made of a water-resistant material, such as plastics and flexible films. However, when the package container or the support is made of plastic or the like, problems occur such as bulky garbage after use and a large burden on the environment. Therefore, in one preferred embodiment of the present invention, the package container or the support is preferably water-resistant paper. The water-resistant paper is not particularly limited. As one example, a laminate of 12 μm-thick polyethylene terephthalate on one surface (surface in contact with frozen gyoza dumplings in the present specification) of single side coated card B with a basis weight (fabric weight) of 310 g/m2 (hereinafter also referred to as “single side coated card B 310 g/inner surface PET 12μ” can be mentioned. In the aforementioned FIG. 3-1 to FIG. 3-3, water-resistant paper 300 can be used as a flat support. In FIG. 2-1, FIG. 2-2, FIG. 3-1, and FIG. 3-2, paper with water-resistant inner surface can be used as a flat packaging bag 200. Furthermore, it is preferable to use water-resistant paper for at least the inner bottom surface, preferably the inner bottom surface and the inner side surface, and further, the inner top surface when the top surface is provided, of the box body 400 in FIG. 4-1 and FIG. 4-2; for at least the inner bottom surface, preferably the inner bottom surface and the inner side surface, and further, the inner top surface when the top surface is provided, of the box body 500 in FIG. 5-1 and FIG. 5-2; and for at least the inner bottom surface, preferably the inner bottom surface and the inner side surface, and further, the inner top surface when the top surface is provided, of the box body 500 in FIG. 6-1 and FIG. 6-2.

The frozen gyoza dumplings with a support of the present invention is characterized in that it affords sliding of the Connected Frozen Gyoza 100 on the support. It has solved at least partially the problems with conventional frozen gyoza dumpling products, for example, that frozen gyoza dumplings have to be placed one by one on a cooking utensil such as a frying pan, and therefore, a wing-forming frozen composition thaws before all the frozen gyoza dumplings have been placed, and they do not cook well. The present invention therefore does not exclude Connected Frozen Gyoza 100 broken into two or more pieces when placed, as long as a plurality of frozen gyoza dumplings can be placed on a cooking utensil at once by sliding on the support. Furthermore, even if Connected Frozen Gyoza 100 is dropped while being enclosed in a package container during the process of storage, transportation, and distribution, the Connected Frozen Gyoza 100 broken into two or more pieces is not excluded from the present invention as long as the connection state of the dumplings therein is partially maintained. However, considering the beauty of the finish (arrangement of gyoza dumplings, etc.), it is desirable that the Connected Frozen Gyoza 100 can not only be taken out as it is, but also can be placed on a cooking utensil while frozen gyoza dumplings therein are completely connected and/or the connected state is not completely lost even if Connected Frozen Gyoza 100 is dropped. Moreover, it is desirable to achieve the effect without deteriorating the quality such as taste.

In the present invention, the thickness Tl (FIG. 1(a-2)) of the wing-forming frozen composition 102 connecting a plurality of frozen gyoza dumplings 101 is, for example, 3 to 10 mm, preferably 4 to 8 mm, and more preferably 4 to 7 mm. As shown in the examples below, when the thickness of the wing-forming frozen composition is within this range, the wing-forming frozen composition 102 does not crack even if Plural Connected Frozen Gyoza 100 enclosed in a package container is dropped, Plural Connected Frozen Gyoza 100 can be slid on a package container or a support even if it is refrozen after being thawed once, and the wing-forming composition does not remain unburned.

In the present invention, the distance between the closest frozen dumplings 101 in the Connected Frozen Gyoza 100 is, for example, 3 to 10 mm, preferably 4 to 10 mm, more preferably 5 to 10 mm. As used herein, the “distance between the closest frozen gyoza dumplings 101” refers to the shortest distance between adjacent frozen gyoza dumplings 101. It is D1 in the example of the tandem type shown in FIGS. 1(a), and D2 in the example of the disc type shown in FIG. 1(c). As shown in the following Examples, when the distance between the closest frozen gyoza dumplings 101 is within this range, the wing-forming frozen composition 102 does not crack even if Plural Connected Frozen Gyoza 100 enclosed in a package container is dropped, Plural Connected Frozen Gyoza 100 can be slid on a package container or a support even if it is refrozen after being thawed once, and the wing-forming composition does not remain unburned.

While the present invention is more specifically explained in the following by referring to Examples, the present invention is not limited to the following Examples.

Other features of the invention will become apparent in the course of the following descriptions of exemplary embodiments which are given for illustration of the invention and are not intended to be limiting thereof.

### EXAMPLES

### [Preparation of Gyoza Dumpling]

The gyoza dumplings of “GYOZA” manufactured by Ajinomoto Co., Inc., which were frozen after filling, wrapping and forming, were thawed in a refrigerator (−5° C.)

### [Preparation of Wing-Forming Composition]

A wing-forming composition of the formulation indicated in Table 1 was prepared.

TABLE 1

| | |
|---|---|
| water | 77.33 |
| starch | 0.82 |
| processed starch | 4.71 |
| salad oil | 16.41 |
| emulsifier | 0.45 |
| thickener | 0.28 |
| subtotal | 100.0 |

(unit: wt %)

All powder materials were put into water and mixed in a homogenizer (“ULTRA-TURRAX T50 basic” manufactured by IKA-WERKE) for 3 min (resulting product A). Lecithin as an emulsifier and xanthan gum as a thickener were added to salad oil and mixed with a rubber spatula (resulting product B). Finally, a wing-forming composition was prepared by adding resulting product B into resulting product A little by little while stirring in the aforementioned homogenizer, and mixing them for 5 min.

### [Production of Plural Connected Frozen Gyoza 100 Connected by Wing-Forming Frozen Composition 102]

The wing-forming composition prepared above was filled in a cuboid container made of single side coated card B 310 g/inner surface PET 12μ (long side 18 cm×short side 7 cm×height 5.5 cm), and a container with an inverted conical trapozoidal shape (bottom surface diameter of 14 cm, 16 cm, 18 cm, or 20 cm, height of 2 cm, and an inclination angle of the side surface of 45 degrees from the vertical direction), gyoza dumplings thawed above were placed thereon, and steamed at 95 to 100° C. for 9 min in a steam convection oven (manufactured by Hoshizaki Electric Co., Ltd., “MIC-6SA3-1”). After heating, they were frozen in a quick freezer (inside temperature: −30° C.)

[Production of Frozen Gyoza Dumplings with a Support]

Plural Connected Frozen Gyoza 100 connected by a wing-forming frozen composition 102 was detached from the container, and placed in the following package container.

### Embodiment 1

Plural Connected Frozen Gyoza 100 alone connected by a wing-forming frozen composition 102 was directly placed in a bag 200 (material and thickness: laminate of easy-adhesive polyethylene terephthalate (thickness 12 μm) and linear low-density polyethylene (thickness 40 μm), size: 23 cm long side×12 cm short side rectangle (tandem type) or 26 cm square (disc type) in plan view.

### Embodiment 2

Plural Connected Frozen Gyoza 100 connected by a wing-forming frozen composition 102 was placed in a bag 200 (material and thickness: laminate of easy-adhesive polyethylene terephthalate (thickness 12 μm) and linear low-density polyethylene (thickness 40 μm), size: 23 cm long side×12 cm short side rectangle (tandem type) or 26 cm square (disc type) in plan view, while being placed on single side coated card B 310 g/inner surface PET 12μ 300 (18 cm long side×7 cm short side rectangle (tandem type) or 20 cm square (disc type) in plan view.

### Embodiment 3

Plural Connected Frozen Gyoza 100 connected by a wing-forming frozen composition 102 was placed in a package container 400 made of single side coated card B 310 g/inner surface PET 12μ, in which one short side surface 401 of a cuboid (long side 18 cm×short side 7 cm×height 5.5 cm) was inclined by 45 degrees from the vertical direction; and a box body 400 made of single side coated card B 310 g/inner surface PET 12μ, in which the whole side surface 401 of an inverted conical trapozoid with a bottom surface diameter of 14 cm, 16 cm, 18 cm, or 20 cm, and a height of 2 cm was inclined by 45 degrees from the vertical direction.

### Embodiment 4

Plural Connected Frozen Gyoza 100 connected by a wing-forming frozen composition 102 was placed in a package container 500 made of single side coated card B 310 g/inner surface PET 12μ, in which one short side surface 501 of a cuboid (long side 18 cm×short side 7 cm×height 5.5 cm) can be opened to be aligned with the bottom surface of the cuboid; and a package container 500 made of single side coated card B 310 g/inner surface PET 12μ, in which the whole side surface 501 of an inverted conical trapozoid with a bottom surface diameter of 14 cm, 16 cm, 18 cm, or 20 cm, a height of 5 cm and an inclination angle of the side surface of 45 degrees from the vertical direction can be opened to be aligned with the bottom surface of the inverted conical trapozoid.

The inverted conical trapozoid in this embodiment with no top surface was used in the following Examples.

### Embodiment 5

Plural Connected Frozen Gyoza 100 connected by a wing-forming frozen composition 102 was placed in a package container 600 which is a cuboid made of single side coated card B 310 g/inner surface PET 12μ (long side 18 cm×short side 7 cm×height 5.5 cm) provided with a tear-off zipper 610 (with a width of 1.5 cm at 2 cm from one end of the long side on each surface, to transversely cross the top surface, both side surfaces, and the bottom surface, and is pulled off in the vertical direction), and a package container 600 with a cylindrical shape made of single side coated card B 310 g/inner surface PET 12μ, with a bottom surface diameter of 20 cm and a height of 5.5 cm and provided with a tear-off zipper 610 (with a width of 5 cm around the entire circumference of the side surface and pulled off in the transverse direction).

In the following Examples of this Embodiment, a cuboid was produced by combining two box bodies without a top surface (frozen gyoza dumplings were placed on the bottom surface of one of the box bodies before combining them). A cylindrical shape was produced by placing the frozen gyoza dumplings on the bottom surface of a box without a top surface and then attaching a top surface.

### [Test Section (1)]

Connected Frozen Gyoza 100 connected by a wing-forming frozen composition 102 into a tandem type or a disc type was placed in a package container, and whether it can be slid on the inside surface of the package container and put on a frying pan was confirmed.

### Test Method

Frozen gyoza dumplings with a support were produced as described above. The thickness of the wing-forming frozen composition 102 was set to 5 mm, and the distance between the closest frozen gyoza dumplings 101 was set to 5 mm. The evaluation criteria are shown in Table 2, and the evaluation results are shown in Table 3. In this test section, the number of connected frozen gyoza dumplings was 6 for the tandem type, and the number of connected frozen gyoza dumplings was 8 for the disc type. For the disc type, in Embodiments 1 and 3, those produced using containers with bottom surface diameters of 14 cm, 16 cm, 18 am, and 20 cm were respectively placed in containers with bottom surface diameters of 14 cm, 16 cm, 18 cm, and 20 cm, but the results remained the same. In Embodiments 2 and 4, one produced using a container with a bottom surface diameter of 18 cm was placed in a package container with a bottom surface diameter of 18 cm. In Embodiment 5, one produced using a container with a bottom surface diameter of 18 cm was placed in a package container with a bottom surface diameter of 20 cm.

TABLE 2
Evaluation criteria

| | |
|---|---|
| slidability | ◯: gyoza dumplings can be slid and arranged on |
| | frying pan |
| | Δ: gyoza dumplings can be slid and arranged on |
| | frying pan but connected frozen gyoza dumpling |
| | is broken into two or more pieces when arranging |
| | X: gyoza dumplings cannot be slid or arranged on |
| | frying pan |

* ◯ and Δ are acceptable.

TABLE 3
Evaluation results

| | | arrangement of gyoza | |
|---|---|---|---|
| Example, Comparative | | dumplings | |
| Example No. | Embodiment | tandem type | disc type |
| Example 1 | 1 | ◯ | ◯ |
| Example 2 | 2 | ◯ | ◯ |
| Example 3 | 3 | ◯ | ◯ |
| Example 4 | 4 | ◯ | ◯ |
| Example 5 | 5 | ◯ | ◯ |

As is clear from Table 3, Connected Frozen Gyoza 100 connected by a wing-forming frozen composition 102 could be slid and placed on a frying pan in all Embodiments 1 to 5, irrespective of tandem type or disc type.

### [Test Section (2)]

The frozen gyoza dumplings with a support of the present invention do not use a tray used for conventional frozen gyoza dumplings. Therefore, there is a possibility that the wing-forming frozen composition 102 melts and sticks to the package container when taking the frozen gyoza dumplings home in summer, a possibility that the wing-forming frozen composition 102 cracks easily when dropped, and a possibility that the wing-forming frozen composition easily remains unburned. Accordingly, it was confirmed whether these problems could be solved by varying the thickness of the wing-forming frozen composition 102.

### Test Method

The distance between the closest frozen gyoza dumplings 101 was 5 mm, and Plural Connected Frozen Gyoza 100 was produced using a wing-forming frozen composition 102 while changing the amount of the wing-forming composition. Thereafter, frozen gyoza dumplings with a support of Embodiment 2 were produced for tandem type, and frozen gyoza dumplings with a support of Embodiment 1 were produced for disc type. They were stored in a freezer at −18° C. and then subjected to the following tests.

Take-out test: Frozen gyoza dumplings with a support were placed in an incubator (“MIR-153” manufactured by Sanyo Electric Co., Ltd.) at 30° C. at an inclination angle of 45 degrees to give frozen gyoza dumplings with a support. After 20 min, they were refrozen in a quick freezer. Thereafter, it was confirmed whether Plural Connected Frozen Gyoza 100 could be slid in a connected state and arranged on a frying pan.

Drop test: Dropped once perpendicularly from a height of 30 cm to confirm cracking of the wing-forming frozen composition 102.

Cooking test: The frying pan was covered with a lid and gyoza dumplings were steamed for 5 min. Then the lid was removed and the gyoza dumplings were cooked until they were browned.

Evaluation criteria are shown in Table 4, the evaluation results of the tandem type are shown in Table 5, and the evaluation results of the disc type are shown in Table 6. In this test section, the number of connected frozen gyoza dumplings was 6 for the tandem type, and the number of connected frozen gyoza dumplings was 8 for the disc type. The data obtained using a container with a bottom surface diameter of 18 cm is shown for the disc type (test was also performed using containers with bottom surface diameters of 14 cm, 16 cm, and 20 cm, but the results were the same).

TABLE 4

| | |
|---|---|
| slidability | ⊚: slide easily |
| | ◯: can slide |
| | X: cannot slide |
| cracking of wing-forming | ◯: does not crack |
| frozen composition | X: cracks |
| unburnt residue | ⊚: no unburnt residue |
| | ◯: slightly remains unburned |
| | X: remains unburned |

TABLE 5

| | thickness (mm) | | cracking of | |
|---|---|---|---|---|
| Example, | of wing- | | wing-forming | |
| Comparative | forming frozen | | frozen | unburnt |
| Example No. | composition | slidability | composition | residue |
| Example 6 | 1 | ◯ | X | ⊚ |
| Example 7 | 3 | ◯ | ◯ | ⊚ |
| Example 8 | 5 | ⊚-◯ | ◯ | ⊚-◯ |
| Example 9 | 10 | ⊚-◯ | ◯ | ◯ |
| Example 10 | 15 | ⊚-◯ | ◯ | X |
| Example 11 | 20 | ⊚-◯ | ◯ | X |

TABLE 6

| | thickness (mm) | | cracking of | |
|---|---|---|---|---|
| Example, | of wing- | | wing-forming | |
| Comparative | forming frozen | | frozen | unburnt |
| Example No. | composition | slidability | composition | residue |
| Example 12 | 1 | ⊚ | ◯ | ⊚ |
| Example 13 | 3 | ⊚ | ◯ | ◯ |
| Example 14 | 5 | ⊚ | ◯ | ◯ |
| Example 15 | 10 | ⊚ | ◯ | ◯ |
| Example 16 | 15 | ⊚ | ◯ | X |

From Table 5 and Table 6, it is clear that sliding is possible even when the thickness of the wing-forming frozen composition is changed. From Table 5, it is clear that, in the tandem type, the optimum range of the thickness of the wing-forming frozen composition 102 is 3 to 10 mm from the aspects of the cracking of the wing-forming frozen composition 102 and the unburnt residue of wing-forming composition. From Table 6, it is clear that, in the disc type, the optimum range of the thickness of the wing-forming frozen composition 102 is 1 to 10 mm from the aspects of the cracking of the wing-forming frozen composition 102 and the unburnt residue of wing-forming composition.

### [Test Section (3)]

As explained in test section (2), the frozen gyoza dumplings with a support of the present invention do not use a tray used for conventional frozen gyoza dumplings. Therefore, there is a possibility that the wing-forming frozen composition 102 melts and sticks to the package container when taking the frozen gyoza dumplings home in summer, a possibility that the wing-forming frozen composition 102 cracks easily when dropped, and a possibility that the wing-forming frozen composition easily remains unburned. Accordingly, in this test section, it was confirmed whether these problems could be solved by varying the distance between the closest frozen gyoza dumplings 101.

### Test Method

In the same manner as in test section (2) except that the thickness of the wing-forming frozen composition 102 was set to 5 mm and the distance between the closest frozen gyoza dumplings 101 was changed, Plural Connected Frozen Gyoza 100 was produced using a wing-forming frozen composition 102. The evaluation criteria were also the same as in Table 4. The evaluation results of the tandem type are shown in Table 7, and the evaluation results of the disc type are shown in Table 8.

The data obtained using a container with a bottom surface diameter of 18 cm is shown for the disc type (test was also performed using containers with bottom surface diameters of 14 cm, 16 cm, and 20 cm, but the results were the same).

TABLE 7

| | distance (mm) | | | wing-forming | | cracking of | |
|---|---|---|---|---|---|---|---|
| Example, | between the | wing-forming | number of | composition area | | wing-forming | |
| Comparative | closest frozen | composition | gyoza | (cm²)/gyoza | slida- | frozen | unburnt |
| Example No. | gyoza dumplings | area (cm²) | dumplings | dumpling | bility | composition | residue |
| Example 17 | 1 | 126 | 6 | 21 | ⊙ | O | X |
| Example 18 | 3 | 126 | 6 | 21 | O | O | O |
| Example 19 | 5 | 126 | 5 | 25.2 | O | O | ⊙ |
| Example 20 | 10 | 126 | 4 | 31.5 | O | O | ⊙ |
| Example 21 | 15 | 126 | 4 | 31.5 | O | X | ⊙ |
| Example 22 | 20 | 126 | 3 | 42 | O | X | ⊙ |

TABLE 8

| | distance (mm) | | | wing-forming | | cracking of | |
|---|---|---|---|---|---|---|---|
| Example, | between the | wing-forming | number of | composition area | | wing-forming | |
| Comparative | closest frozen | composition | gyoza | (cm²) /gyoza | slida- | frozen | unburnt |
| Example No. | gyoza dumplings | area (cm²) | dumplings | dumpling | bility | composition | residue |
| Example 23 | 1 | 226.9 | 10 | 22.7 | ⊙ | O | X |
| Example 24 | 3 | 226.9 | 9 | 25.2 | ⊙ | O | O |
| Example 25 | 5 | 226.9 | 8 | 28.4 | ⊙ | O | ⊙ |
| Example 26 | 10 | 226.9 | 7 | 32.4 | ⊙ | O | ⊙ |
| Example 27 | 15 | 226.9 | 6 | 37.8 | ⊙ | O | ⊙ |
| Example 28 | 20 | 226.9 | 5 | 45.4 | ⊙ | O | ⊙ |

From Table 7 and Table 8, it is clear that sliding is possible even when the distance between the closest frozen gyoza dumplings is changed. From Table 7, it is clear that, in the tandem type, the optimum range of the distance between the closest frozen gyoza dumplings is 3 to 10 mm from the aspects of the cracking of the wing-forming frozen composition 102 and the unburnt residue of wing-forming composition. From Table 8, it is clear that, in the disc type, the optimum range of the distance between the closest frozen gyoza dumplings is 3 to 20 mm from the aspects of the cracking of the wing-forming frozen composition 102 and the unburnt residue of wing-forming composition.

### INDUSTRIAL APPLICABILITY

According to the frozen gyoza dumplings with a support of the present invention, it is possible to arrange gyoza dumplings all at once on a cooking utensil such as a frying pan without touching the gyoza dumplings with a hand. In addition, the frozen gyoza dumplings with a support of the present invention makes it possible to omit the use of a tray made of plastic, and garbage generated after cooking which is to be thrown away is not bulky and environmentally friendly.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. Frozen gyoza dumplings with a support, comprising a plurality of frozen gyoza dumplings connected by a wing-forming frozen composition, and a support in contact with a connecting surface thereof, wherein the support has a shape permitting the frozen gyoza dumplings in a connected state to slide thereon, or is deformed so as to permit sliding.

2. The frozen gyoza dumplings according to claim 1, wherein the support is a package container, and the plurality of connected frozen gyoza dumplings is directly enclosed in the package container.

3. The frozen gyoza dumplings according to claim 2, wherein the package container is an outer packaging bag.

4. The frozen gyoza dumplings according to claim 2, wherein the package container is a box body.

5. The frozen gyoza dumplings according to claim 1, wherein the support is a flat plate body or a deformed body thereof, or a box body.

6. The frozen gyoza dumplings according to claim 5, wherein the plurality of connected frozen gyoza dumplings and the support are enclosed in a bag.

7. The frozen gyoza dumplings according to claim 4 or 5, wherein at least a surface of the package container or the support, which surface is in contact with the plurality of connected frozen gyoza dumplings, is water resistant.

8. The frozen gyoza dumplings according to claim 7, wherein the package container or the support is water-resistant paper.

9. The frozen gyoza dumplings according to any one of claims 1 to 8, wherein the connecting surface of the plurality of connected frozen gyoza dumplings is polygonal or substantially circular.

10. The frozen gyoza dumplings according to claim 4 or any one of claims 5 to 8 in which the support is a box body, wherein all or a part of the side surfaces of the box body does not exist or is deformed so as to not exist, or is inclined at 30 degrees or more from the vertical direction or deformed so as to be inclined, so that the plurality of connected frozen gyoza dumplings is taken out in a connected state from the box body by sliding the frozen gyoza dumplings on the box body.

11. The frozen gyoza dumplings according to claim 10, wherein the all or part of the side surfaces of the box body is inclined 30 to 90 degrees from the vertical direction.

12. The frozen gyoza dumplings according to claim 10, wherein the all or part of the side surfaces of the box body is deformed to be aligned with the bottom surface of the box body.

13. The frozen gyoza dumplings according to claim 10, wherein the box body comprises a tear-off zipper, and all or a part of the side surfaces of the box body is broken by pulling off the tear-off zipper.

14. The frozen gyoza dumplings according to any one of claims 1 to 13, wherein the wing-forming frozen composition has a thickness of 3 to 10 mm.

15. The frozen gyoza dumplings according to any one of claims 1 to 14, wherein a distance between the closest frozen gyoza dumplings is 3 to 10 mm.
